(19) United States
(12) Patent Application Publication
(10) Pub. No.: US 2026/0269959 A1
(43) Pub. Date: Sep. 10, 2026

(54) CLOSED FORM MODEL BASED DC CALIBRATION METHODS AND SYSTEMS FOR WIRELESS COMMUNICATION DEVICES

(71) Applicant: Morse Micro Pty. Ltd., Surry Hills NSW (AU)

(72) Inventor: Rajendra Yogaraj, Surry Hills NSW (AU)

(21) Appl. No.: 19/406,388

(22) Filed: Dec. 2, 2025

(30) Foreign Application Priority Data
Mar. 6, 2025 (AU) 2025900680

(51) Int. Cl. H04B 17/21

(52) U.S. Cl. CPC H04B 17/22

(57) ABSTRACT

A DC calibration method for correcting a DC offset in a signal received by a wireless communication device. The DC calibration method includes run time evaluating of a closed form mathematical model for predicting a DC level, selecting a bmag value from a predetermined range, calculating a trim code from the bmag value according to the mathematical model, comparing the trim code with an allowable trim code range associated with the bmag value, updating the bmag value to recalculate the trim code according to the mathematical model until the trim code is within the allowable trim code range, and upon the trim code is within the allowable trim code range, performing DC calibration on the received signal using the bmag value and trim code.

### CROSS REFERENCE TO RELATED APPLICATION

The present application claims priority from Australian provisional patent application number 2025900680 filed on 6 Mar. 2025, the contents of which are incorporated herein by cross-reference.

### FIELD OF THE INVENTION

The present disclosure generally relates to wireless communication devices. Specifically, aspects of the present disclosure are related to Direct Current (DC) calibration for radio transceivers in wireless communication devices.

### BACKGROUND

A wireless communication device, such as a Wi-Fi-enabled device, requires precise Direct Current (DC) calibration to ensure signal integrity and minimize distortions. DC offset is a constant shift of the baseband signal arising from various non-idealities in the analog circuitry. These analog imperfections include mixer mismatch, Power Amplifier (PA) leakage, Local Oscillator (LO) feedthrough, Digital-to-Analog Converter (DAC) asymmetry, or any combination thereof. If uncorrected, DC offset can interfere with the desired signal, reduce the receiver dynamic range, and degrade demodulation accuracy. Accordingly, radio transceivers commonly implement DC calibration to detect and compensate such offset by applying corrective measures to the circuitry. In typical implementations, calibration adjusts analog parameters that influence the DC offset and its correction resolution. Examples include a trim code, which is a discrete setting that tunes an analog parameter in small steps; and a bmag value referring to bias-magnitude control that sets the range of an analog correction, which scales the applied DC correction. The bmag value governs the correction range, while the trim code determines step granularity. The DC calibration process aims to make sure the output signal accurately reflects the input, free from the influence of the DC offset.

DC calibration may be executed algorithmically. The DC offset can be modeled as a function of controllable parameters; the system measures DC levels across selected configurations, analyses the measurements, and estimates model coefficients (e.g., via regression or lookup tables), and programs the settings accordingly. Use of model-based estimation and precomputed matrices enables fast convergence and fine resolution, which is advantageous in transceivers spanning wide frequency ranges and complex architectures.

DC calibration is critical for maintaining signal integrity in high-performance transceivers, especially as modern wireless devices span wider frequency ranges and demand stricter tolerances. Accurate DC offset compensation enables optimal performance, reduced power consumption, and improved reliability across applications from mobile communications to Internet of Things (IoT) use cases.

### SUMMARY

The following summary presents technical features relating to one or more aspects of disclosed herein and should not be considered as an extensive overview relating to all contemplated aspects. Accordingly, the following summary has the sole purpose to present certain concepts relating to one or more embodiments relating to DC calibration disclosed herein in a simplified form to precede the detailed description presented below.

A DC calibration method corrects a DC offset in a signal received by a wireless communication device operating in a wireless communication network. Modelling the correction as a closed form expression involving bmag and trim and their run time computation on silicon. Embodiments of the DC calibration method include deriving a mathematical model for predicting a DC level introduced in a receiver system of the wireless communication network by run time evaluating one or more model parameters, selecting a bmag value from a predetermined range, calculating a trim code from the bmag value according to the mathematical model, comparing the trim code with an allowable trim code range associated with the bmag value, updating the bmag value to recalculate the trim code according to the mathematical model until the trim code is within the allowable trim code range, and performing DC calibration on the received signal using the bmag value and trim code when the trim code is within the allowable trim code range.

In some embodiments, the bmag value is selected by selecting a lowest value satisfying calibration requirements, and the bmag value is updated by incrementally increasing the bmag value until the trim code lies within the allowable trim code range. Some embodiments of the DC calibration method further include run time computing a set of model parameters for the mathematical model. Some embodiments of the set of model parameters are run time computed by obtaining DC level measurements of the receiver system corresponding to distinct combinations of bmag values and trim codes during system boot-up. For example, the set of model parameters includes four parameters, and is determined based on four DC level measurements corresponding to four distinct combinations. The DC level measurements can be obtained through baseband first in first out (FIFO) captures during system initialization. In some embodiment, the set of model parameters is determined according to the DC level measurements using a pre-stored inverse matrix, where the pre-stored inverse matrix is derived based on the distinct combinations of bmag values and trim codes. In one embodiment, the pre-stored inverse matrix is a reduced size matrix representing a relationship between DC level measurement differences and partial model parameters, where the DC level measurement differences are differences between a first DC level measurement and each of the remaining DC level measurements.

The allowable trim code range is standardized for all bmag values or the allowable trim code range for one bmag value can be different for that of another bmag value. In one embodiment, the bmag value is selected from a predetermined range by dynamically selecting the lowest effective bmag value for a given receiver gain code. In some embodiments of the DC calibration method, DC calibration for an In-phase (I) path and a Quadrature (Q) path are performed using a shared bmag value but separate trim codes.

Some other embodiments of the DC calibration method include deriving a cost function based on a mathematical model for predicting a DC level introduced in a receiver system of the wireless communication device, calculating a cost using the cost function based on a bmag value and a trim code, comparing the cost with a threshold, upon determining the cost exceeding the threshold, iteratively updating the bmag value and trim code according to gradients of the cost function until the cost is below the threshold, and performing DC calibration on the received signal using the bmag value and trim code when the cost is below the threshold.

In some embodiments, the bmag value is chosen from an allowable bmag range while the trim code is chosen from an allowable trim code range. Some embodiments of the DC calibration method run time compute a set of model parameters for the mathematical model by obtaining DC level measurements of the receiver system corresponding to distinct combinations of bmag values and trim codes.

The cost function used in the DC calibration method is a square of an error between a predicted DC level from the mathematical model and a target DC level in accordance with an embodiment of the present invention. The bmag value and trim code are iteratively updated according to the respective gradients of the cost function and respective damping factors. For example, the gradient of the cost function for updating the bmag value is derived from partial derivation of the cost function with respect to the bmag value, and the gradient of the cost function for updating the trim code is derived from partial derivative of the cost function with respect to the trim code. The bmag value is updated by deducting the product of the corresponding gradient and bmag damping factor from the bmag value, similarly, the trim code is updated by deducting the product of the corresponding gradient and trim code damping factor from the trim code.

One aspect of the present invention is a wireless communication device operating in a wireless communication network, including a receiver system, a mixer, a calibration processor, a DC offset correction circuit, a baseband filter and an analog-to-digital converter (ADC). The receiver system receives a signal and the mixer down-converts the received signal from a radio frequency to a baseband frequency. The calibration processor is configured to execute a closed-form DC calibration algorithm to determine a bmag value and a trim code. The algorithm includes deriving a mathematic model for predicting a DC level introduced in the receiver system by run time evaluating one or more model parameters, selecting an initial bmag value from a predetermined range, calculating an initial trim code from the initial bmag value according to the mathematical model, comparing the initial trim code with an allowable trim code range, and iteratively updating the initial bmag value to recalculate the trim code according to the mathematical model until the trim code is within the allowable trim code range. The calibration processor determines the bmag value and trim code when the trim code is within the allowable trim code range. The DC offset correction circuit generates a DC correction signal according to the bmag value and trim code. The baseband filter receives the down-converted signal and DC correction signal and removes unwanted frequency components, and the ADC further converts from analog signal to digital samples.

In some embodiments, the close-form DC calibration algorithm further obtains DC level measurements of the receiver system associated with distinct combinations of bmag values and trim codes, and run time computes a set of model parameters for the mathematical model based on the DC level measurements and the distinct combinations.

Other objects and advantages associated with the aspects disclosed herein will be apparent to those skilled in art based on the accompanying drawings and detailed description.

### BRIEF DESCRIPTION OF THE DRAWINGS

Illustrative aspects of the present application are described in detail below with reference to the following drawing figures:

FIG. 1 illustrates a block diagram of a receiver system of a wireless communication device with DC calibration in accordance with an embodiment of the present invention.

FIG. 2 illustrates a block diagram of a receiver system of a wireless communication device with DC calibration applied to both I and Q paths in accordance with an embodiment of the present invention.

FIG. 3 illustrates a simplified block diagram of a wireless communication device in accordance with an embodiment of the present invention.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth to provide a thorough understanding of aspects of the application. However, it will be apparent that various embodiments may be practiced without these specific details. The following description of the embodiments will provide those skilled in the art with an enabling description for implementing an example aspect. Changes may be made in the function and arrangement of elements without departing from the spirit and scope of the application as set forth in the claims.

DC calibration corrects DC offsets caused by various non-idealities in analog circuitry. For example, in a direct-down-conversion receiver, any energy from the Local Oscillator (LO) circuit leaks into the RF front-end generates a small LO frequency component at the RF input to the mixer. This component mixes with the proper LO input to the mixer creating an unwanted DC offset at the baseband mixer output. Other unavoidable leakages may come through supply coupling, magnetic coupling, and mixer mismatch. These leakages are inevitable in System on Chip (SoC) solutions as it is difficult to achieve perfect isolation between components when these components are built on the same substrate. Even a small DC offset at an early stage of the receiver chain can be amplified up through the chain to produce significant DC energy at the Analog to Digital Converter (ADC) input.

Straight-line fitting DC calibration algorithms were used for DC correction and typically rely on setting a key parameter, bias magnitude (bmag) value, followed by a binary search to find the right trim code for a particular bandwidth across the gain codes. The bmag value determines the extent of DC correction. While this approach is effective for simpler systems, it becomes less scalable as hardware complexity increases. For instance, conventional algorithms set the bmag value to a fixed value, or selected from a predefined range, without automatically determining the lowest or most efficient value for DC correction, resulting in suboptimal calibration time and unnecessary processing overhead. High-performance systems often demand finer precision in DC calibration. As correction resolution increases, more bits are required to represent the bmag value. This expansion enlarges the potential search space, thereby increasing computational complexity and calibration duration to search across bmag values. Furthermore, the number of First-In-First-Out (FIFO) captures, which are used to collect data for DC calibration, grows linearly with the number of bmag values evaluated, further contributing to longer calibration duration.

To address these challenges, the present invention introduces closed form algorithms for DC calibration that leverages the underlying relationship between bmag values, trim codes, and DC levels. The DC levels in the In-phase (I) component and Quadrature phase (Q) component vary with different trim codes for bmag values. Embodiments of the closed form DC calibration algorithm dynamically select the lowest effective bmag value, thereby reducing the number of FIFO captures required, and optimizing the overall DC calibration time. The effective bmag value is chosen based on the statistical characteristics of the intrinsic DC offset of the system associated with each gain code. The intrinsic DC offset of a given gain code refers to the DC offset measured before any calibration, corresponding to the inherent DC offset of each receiver gain stage setting. In contrast, the residual DC offset represents the remaining DC error after DC calibration. For gain codes exhibiting a large intrinsic DC offset, a large bmag value is used to achieve sufficient DC correction, though this typically results in a large residual DC offset. Conversely, for gain codes with smaller intrinsic DC offsets, small bmag values enable finer trimming resolution and more precise DC correction.

In some embodiments, the closed form DC calibration algorithm is derived from mathematical modeling. The model assumes that (1) a DC current is a linear function of the bmag value, (2) the DC current is a linear function of the trim code, and (3) the DC current is a joint function of both the bmag value and trim code. This framework enables efficient prediction of DC levels and supports rapid convergence during DC calibration. An exemplary mathematical model is expressed in Equation [1]

$$dc = ( α \times bmag \times trim ) + ( β \times bmag ) + ( γ \times trim ) + δ . \qquad Equation [ 1 ]$$

The four model parameters α, β, γ, and δ can be estimated by evaluating the DC levels corresponding to four distinct combinations of bmag values and trim codes. For example, the system acquires measurements dc₀ to dc₃ through FIFO captures during system boot-up, where dc₀ is obtained using (bmag₀, trim₀), dc₁ is obtained using (bmag₁, trim₁), dc₂ is obtained using (bmag₂, trim₂), and dc₃ is obtained using (bmag₃, trim₃). These four measurements form a system of linear equations that can be expressed in matrix form as shown in Equation [2].

$$[ \begin{matrix}{dc}_{0} \\ {dc}_{1} \\ {dc}_{2} \\ {dc}_{3}\end{matrix} ] = [ \begin{matrix}{bmag}_{0} \times {trim}_{0} & {bmag}_{0} & {trim}_{0} & 1 \\ {bmag}_{1} \times {trim}_{1} & {bmag}_{1} & {trim}_{1} & 1 \\ {bmag}_{2} \times {trim}_{2} & {bmag}_{2} & {trim}_{2} & 1 \\ {bmag}_{3} \times {trim}_{3} & {bmag}_{3} & {trim}_{3} & 1\end{matrix} ] [ \begin{matrix}α \\ β \\ γ \\ δ\end{matrix} ] \qquad Equation [ 2 ]$$

The four model parameters α, β, γ, and δ are derived by solving the equations with the four sets of DC levels measured during system boot-up, and the four combinations of bmag values and trim codes. An embodiment of the present invention enables a pre-stored inverse matrix for rapid run time computation of these model parameters, making this approach computationally feasible in embedded systems. For example, the above system of linear equations can be rewritten into a linear transformation, D=A×p, where D represents a 4 by 1 column vector of the DC levels, A represents the 4 by 4 matrix, and p represents the 4 by 1 column vector of the model parameters. By rearranging this linear transformation, p=A⁻¹×D, the model parameters vector p can be derived by inversing the 4 by 4 matrix. This 4 by 4 matrix A is equal to the four distinct combinations of the bmag values and trim values selected for DC level evaluation. In one example, the four combinations of bmag values and trim codes are: (bmag₀, trim₀)=(0,0) corresponding to dc₀, (bmag₁, trim₁)=(4,128) corresponding to dc₁, (bmag₂, trim₂)=(16,64) corresponding to dc₂, and (bmag₃, trim₃)=(8,256) corresponding to dc₃. The DC level dc₀ is used to evaluate to the model parameter 8. The 4 by 4 matrix A can be optimized further by subtracting dc₀ from other DC level evaluations as shown in Equation [3].

$${dc}^{′} = dc - δ = ( α \times bmag \times trim ) + ( β \times bmag ) + ( γ \times trim ) ; \\ [ \begin{matrix}{dc}_{1} - {dc}_{0} = {dc}_{1}^{′} \\ {dc}_{2} - {dc}_{0} = {dc}_{2}^{′} \\ {dc}_{3} - {dc}_{0} = {dc}_{3}^{′}\end{matrix} ] = [ \begin{matrix}512 & 4 & 128 \\ 1024 & 16 & 64 \\ 2048 & 8 & 256\end{matrix} ] [ \begin{matrix}α \\ β \\ γ\end{matrix} ] \qquad Equation [ 3 ]$$

In one embodiment, the three model parameters α, β, and γ, is evaluated by pre-storing the inverse matrix of the 3 by 3 matrix as shown in Equation 3. For example, the inverse matrix with 12-bit fixed point representation is shown in Equation [4].

$$[ \begin{matrix}α \\ β \\ γ\end{matrix} ] = [ \begin{matrix}- 8 & 0 & 4 \\ 293 & 293 & - 219 \\ 55 & - 9 & - 9\end{matrix} ] [ \begin{matrix}{dc}_{1}^{′} \\ {dc}_{2}^{′} \\ {dc}_{3}^{′}\end{matrix} ] \qquad Equation [ 4 ]$$

Modelling and prediction error analysis are performed to evaluate the accuracy of the proposed mathematical model. Prediction errors for a given bmag value are determined by subtracting the model-estimated DC levels from the corresponding measured DC levels across various trim codes for that bmag value. In one example, raw data for a selected bmag values were captured on silicon under a fixed gain setting of the received RF front end operating on a channel at 924 MHz. These data were used to conduct modeling and prediction error analysis. By comparing the measured DC levels for each selected bmag value with the corresponding model-predicted DC levels, the analysis demonstrates that the mathematical model provides considerable accurate and reliable prediction of DC levels within the system.

In some embodiments, the DC level predictions for a given bamg value exhibit higher accuracy when the trim codes lie within a specific range. For instance, the trim code range may extend from −375 to +375. Although this range can vary depending on the bmag value, in certain embodiments, the trim code range may be standardized across all bmag values to simplify system calibration and reduce implementation complexity.

After establishing the mathematical model with the determined parameters during system boot-up, embodiments of the closed form DC calibration method predict the DC levels in the system for any given bmag value and trim code. Some embodiments of the closed form DC calibration method dynamically identify a bmag value that satisfies the calibration requirements. In some preferred embodiments, the closed form DC calibration method searches for the lowest possible bmag value, as smaller bmag values can reduce current or energy consumption and minimize distortion or noise. The primary objective of DC calibration is to eliminate the DC offset in the system. Based on Equation [1], the system determines that the DC offset is zero when:

$$dc = ( α \times bmag \times trim ) + ( β \times bmag ) + ( γ \times trim ) + δ = 0. \qquad Equation [ 5 ]$$

An embodiment of the closed form DC calibration method selects an initial bmag value from a predetermined range. For example, for a 5-bit bmag parameter, the range of the bmag value extends from 1 to 31. In one embodiment, the closed form DC calibration method begins with the lowest bmag value and computes the corresponding trim code using the following formula rearranged from Equation [5]:

$$trim = \frac{( - 1 ) \times ( δ + β \times bmag )}{α \times bmag + γ} . \qquad Equation [ 6 ]$$

The calculated trim code is then verified to ensure it lies within the allowable trim code range for the given bmag value to prevent saturation. If the calculated trim code exceeds the allowable trim code range, the bmag value is incrementally updated until the resulting trim code falls within the valid range. In one embodiment, the bmag value is increased in steps of one (e.g., from 1 to 2, or from 2 to 3). More generally, the bmag value may be incremented by N, where N is a positive integer, whenever the calculated trim code exceeds the corresponding range limit.

Embodiments of the closed form DC calibration method significantly reduce the number of FIFO captures required during system boot-up, since the closed form DC calibration method can predict DC levels for unexplored combinations of bmag value and trim code using a closed-form model. For instance, only four FIFO captures are needed for a given radio front-end configuration (i.e. gain code) to perform DC correction with a four-parameter closed form mathematical model. The DC calibration scheme can be implemented in software, firmware, or hardware, substantially reducing overall calibration time. This approach is especially advantageous for systems with large bmag ranges, as it avoids exhaustive searches. Furthermore, the use of pre-stored matrices and fixed-point arithmetic enables efficient and seamless integration into existing embedded systems.

In some other embodiments, an alternative DC calibration method employs a steepest gradient descent algorithm to determine the bmag value and trim code that meet the residual error criteria for the resulting DC level. In these embodiments, the model parameters of the mathematical model used to predict the DC current are derived from the DC levels measured through at least four FIFO captures during system boot-up. The mathematical model for predicting the DC level, denoted as predicted_{dc}, is expressed as:

$${predicted}_{d c} = ( α \times bmag \times trim ) + ( β \times bmag ) + ( γ \times trim ) + δ . \qquad Equation [ 7 ]$$

The objective is to jointly minimize the bmag value and trim code to achieve a target DC level (target_{dc}). The cost function is defined by Equation [8].

$$cost = {( {target}_{d c} - {predicted}_{d c} )}^{2} ; \qquad Equation [ 8 ]$$

Given that the desired DC level after DC calibration is zero (i.e., target_{dc}=0), the cost function simplifies to the square of the predicted DC level:

$$cost = {[ ( α \times bmag \times trim ) + ( β \times bmag ) + ( γ \times trim ) + δ ]}^{2} . \qquad Equation [ 9 ]$$

In one embodiment, the first step of the DC calibration method is to initialize the bmag value and trim code with arbitrary values and compute the gradients of the cost function with respect to the bmag value and the trim code. These gradients are calculated based on Equations [10] and [11].

$$\frac{\partial cost}{\partial trim} = 2 \times {predicted}_{d c} \times ( α \times bmag + γ ) ; \qquad Equation [ 10 ]$$

$$\frac{\partial cost}{\partial bmag} = 2 \times {predicted}_{d c} \times ( α \times trim + β ) . \qquad Equation [ 11 ]$$

In one example, the bmag value is selected from a range between 1 and 31, and the trim code is selected from a range between −375 and +375. The cost, calculated as the square of the predicted DC level corresponding to the selected bmag value and trim code, is compared against a predetermined threshold. If the cost exceeds this predetermined threshold, the DC calibration method updates the bmag value and trim code for the next iteration using the computed gradients as shown in Equations [10] and [11]. The updated bmag value, bmag_{new}, and the updated trim code, trim_{new}, are calculated to minimize the cost function as follows:

$${trim}_{new} = trim - {μ}_{trim} \times \frac{\partial cost}{\partial trim} ; \qquad Equation [ 12 ]$$

$${bmag}_{new} = bmag - {μ}_{bmag} \times \frac{\partial cost}{\partial bmag} . \qquad Equation [ 13 ]$$

where μₜᵣᵢₘ and μ_{bmag} are damping factors (or learning rates) for the trim code and bmag value respectively. In an embodiment, these damping factors are chosen experimentally to ensure convergence stability. This iteration process for updating the bmag value and trim code is repeated until the residual error of the predicted DC level, represented by the cost function as shown in Equation [9], is less than the predetermined threshold.

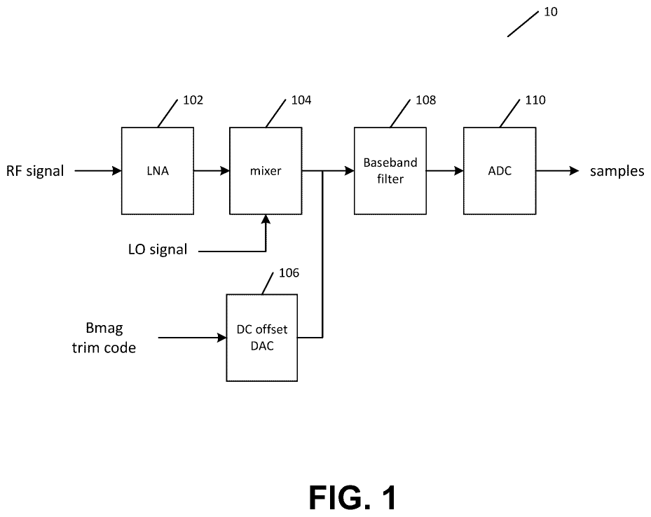

FIG. 1 is a simplified block diagram of a receiver system 10 in a wireless communication device with DC calibration according to an embodiment of the present invention. A Radio Frequency (RF) signal received from an antenna is amplified by a Low Noise Amplifier (LNA) 102 without introducing much noise. The amplified RF signal is then shifted down to a lower frequency by a mixer 104 for easier processing. The mixer 104 translates the radio frequency to baseband frequency by multiplying the high-frequency RF signal with a LO signal. In this embodiment, the mixer generates differential outputs. A DC offset Digital to Analog Converter (DAC) 106 generates a cancellation offset (or a DC correction signal) to reduce the intrinsic DC offset of the system according to bmag value and trim code. Embodiments of the DC calibration procedure involve finding out model parameters of the closed form representation. Once the mathematical model is run time evaluated, it can be used to iteratively evaluate the optimal bmag value and trim code for DC offset correction or through steepest descent gradient search. An embodiment of the DC offset DAC is a current steering DAC with a polarity, allowing the cancellation offset to correct for positive or negative DC offset. In one embodiment, the polarity of the current flow is controlled by the trim code, for example, the Most Significant Bit (MSB) of a 10-bit trim code, trim_code<9>, indicates the polarity. The remaining 9 bits of the trim code, trim_code<8:0>, indicate the trim code value. The overall range and resolution of DC offset correction are determined by the bmag value. Different bmag settings correspond to different unit current magnitudes, effectively defining the resolution of DC offset trimming. For a fix number of bits trim code, a high bmag value indicates coarse trimming (i.e. low resolution) but large trimming range, while a low bmag value indicates finer trimming (i.e. high resolution) but smaller trimming range.

In this embodiment, both the output of the mixer 104 and the cancellation offset output from the DC offset DAC 106 are differential inputs of a baseband filter 108. An example of the baseband filter 108 is an operational amplifier passing the frequency range containing the modulated signal by removing unwanted high-frequency components. In this embodiment, the baseband filter 108 is an analog baseband filter in a direct-conversion receiver. An ADC 110 converts the analog baseband signal from the baseband filter 108 to digital samples based on a clock signal. The digital samples can be fed to a Digital Signal Processing (DSP), digital blocks, or a combination of hardware accelerators and DSP or Micro Controller Unit (MCU) control according to different implementations. The digital blocks include a decimator, which is a digital filter and downsampler reducing bandwidth and sample rate.

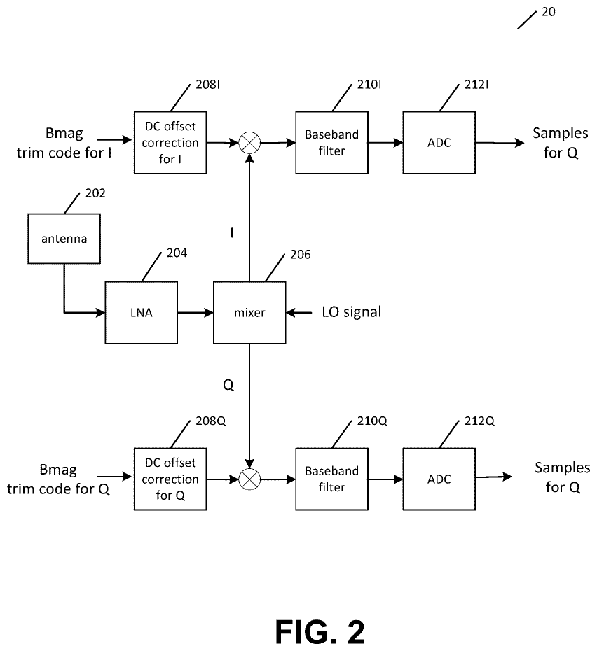

In some embodiments, a DC offset DAC is provided on the I path and another DC offset DAC is provided on the Q path to compensate for independent DC offsets present in the I and Q branches of the received complex signal. FIG. 2 shows a simplified block diagram illustrating a receiver system 20 of a wireless communication device with DC calibration in accordance with an embodiment. An antenna 202 receives RF signals and an LNA 204 amplifies the received RF signal. The mixer 206 mixes the amplified RF signal with a LO to down-convert a radio frequency to a baseband frequency. In this embodiment, the mixer 206 is an I/Q mixer, producing I and Q signals. A DC offset correction circuit 208I generates a DC correction signal for the I signal according to the bmag value and trim code. DC calibration procedure involves run time computing model parameters of a closed form mathematical model, and iteratively evaluating the best bmag value and trim code for DC offset correction or through steepest descent gradient search. Similarly, a DC offset correction circuit 208Q generates a DC correction signal for the Q signal according to the bmag value and trim code. A baseband filter 210I receives a combination of the I signal and the DC correction signal for the I signal, and another baseband filter 210Q receives a combination of the Q signal and the DC correction signal for the Q signal. Each of the baseband filters 210I and 210Q removes unwanted frequency components in the signal. An ADC 212I converts the analog I signal to digital samples and an ADC 212Q converts the analog Q signal to digital samples. In some embodiments, the determined bmag value is shared between both DC offset correction circuits 208I and 208Q, while each DC offset correction circuit utilizes a separate trim code to independently correct the DC offset on its respective path. In some other embodiments, each of the DC offset correction circuits 208I and 208Q generates a corresponding DC correction signal according to a separate bmag value and trim code.

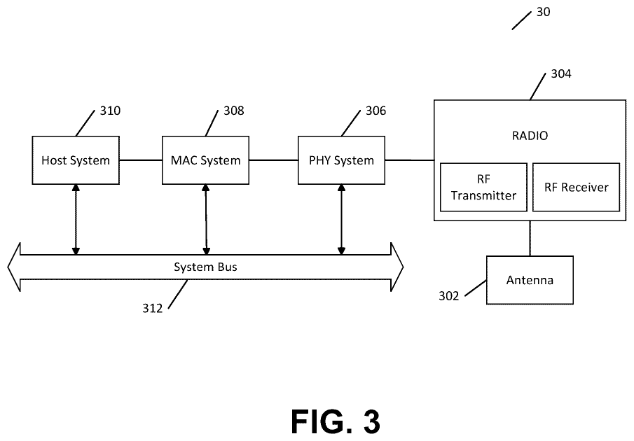

FIG. 3 shows a high-level block diagram of a wireless communication device 30. The wireless communication device 30 manages a Medium Access Control (MAC) layer and a Physical (PHY) layer in compliance with an IEEE 802.11 standard. The wireless communication device 30 is a Station (STA) or an Access Point (AP) of a wireless network. For example, the wireless communication device 30 is in a mobile device, a personal computer, a laptop computer, an Internet of Things (IoT) device, a wearable device, an extended reality device, a video server, a camera, or a communication device on a vehicle. The wireless communication device 30 has a radio module 304 consisting of an RF transmitter and an RF receiver. The RF receiver includes a DC calibration system for determining an appropriate bmag value and trim code to correct the DC offset of a received signal according to one of the embodiments of the present invention. In one embodiment, the DC calibration system determines a mathematical model with model parameters, selects an initial bmag value, derives a trim code using the mathematical model, check if the trim code is within a range, adaptively updates the bmag value and thus updating the trim code until the trim code is within the range, and performs DC calibration on the received signal using the bmag value and trim code. In another embodiment, the DC calibration system determines a cost for an initial bmag value and an initial trim code according to a cost function evaluating a predicted DC level, compares the cost with a threshold, uses gradients to update the bmag value and trim code for a next iteration until the cost is below the threshold.

The wireless communication device 30 further includes an antenna unit 302, a communication system bus 312, a MAC system 304, a PHY system 306, and a HOST system 310. These systems may be implemented individually or in combination with various types of Integrated Circuit (IC), including one or more of a General Processing Unit (GPU), an Application Specific Integrated Circuit (ASIC), or Reduced Instruction Set Computer-Five (RISC-V). The PHY system 306 bridges between the MAC system 308 and the radio front-end 304 and is responsible for modulation and demodulation. Specifically, the packets are transmitted by modulating one or more carrier wave signals to encoded digital information according to a clock signal. Received packets are demodulated to reconstruct the original digital information according to the clock signal. The Host system is responsible for running high level functionalities of the wireless communication device 30. The PHY system 306, the MAC system 308, and the HOST system 310 communicate with each other via the system bus 312. The antenna unit 306 may include a single antenna or multiple antennas.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present application.

What is claimed is:

1. A Direct Current (DC) calibration method for correcting a DC offset in a signal received by a wireless communication device operating in a wireless communication network, comprising:
deriving a mathematical model for predicting a DC level introduced in a receiver system of the wireless communication device by run time evaluating one or more model parameters;
selecting a bmag value from a predetermined range, wherein the bmag value represents bias magnitude that controls range and trimming resolution for DC calibration;
calculating a trim code from the bmag value according to the mathematical model, wherein the trim code represents step granularity for DC calibration;
comparing the trim code with an allowable trim code range associated with the bmag value;
updating the bmag value to recalculate the trim code according to the mathematical model until the trim code is within the allowable trim code range; and
upon the trim code is within the allowable trim code range, performing DC calibration on the received signal using the bmag value and the trim code.

2. The DC calibration method of claim 1, wherein the bmag value is selected by selecting a lowest value satisfying calibration requirements, and the bmag value is updated by incrementally increasing the bmag value until the trim code lies within the allowable trim code range.

3. The DC calibration method of claim 1, wherein deriving the mathematical model by run time evaluating one or more model parameters further comprises run time computing a set of model parameters for the mathematical model during system boot-up.

4. The DC calibration method of claim 3, further comprising obtaining DC level measurements of the receiver system corresponding to distinct combinations of bmag values and trim codes; wherein the set of model parameters is computed based on the DC level measurements corresponding to the distinct combinations of bmag values and trim codes.

5. The DC calibration method of claim 4, wherein the set of model parameters comprises α, β, γ, and δ, and the set of model parameters is computed based on four DC level measurements corresponding to four distinct combinations.

6. The DC calibration method of claim 4, wherein the DC level measurements are obtained through baseband first in first out (FIFO) captures during system initialization.

7. The DC calibration method of claim 4, further comprising using a pre-stored inverse matrix to compute the set of model parameters according to the DC level measurements, wherein the pre-stored inverse matrix is derived based on the distinct combinations of bmag values and trim codes.

8. The DC calibration method of claim 7, wherein the pre-stored inverse matrix is a reduced size matrix representing a relationship between DC level measurement differences and partial model parameters, wherein the DC level measurement differences are differences between a first DC level measurement and each of the remaining DC level measurements.

9. The DC calibration method of claim 1, wherein the allowable trim code range is standardized for all bmag values.

10. The DC calibration method of claim 1, wherein selecting a bmag value from a predetermined range comprises dynamically selecting a lowest effective bmag value for a given receiver gain code.

11. The DC calibration method of claim 1, wherein DC calibration for an In-phase (I) path and a Quadrature (Q) path are performed using a shared bmag value and separate trim codes.

12. A Direct Current (DC) calibration method for correcting a DC offset in a signal received by a wireless communication device operating in a wireless communication network, comprising:
deriving a cost function based on a mathematical model for predicting a DC level introduced in a receiver system of the wireless communication device;
calculating a cost using the cost function based on a bmag value and a trim code, wherein the bmag value represents bias magnitude that controls range and trimming resolution for DC calibration, and the trim code represents step granularity for DC calibration;
comparing the cost with a threshold;
upon determining the cost exceeding the threshold, iteratively updating the bmag value and trim code according to gradients of the cost function until the cost is below the threshold; and
upon determining the cost is below the threshold, performing DC calibration on the received signal using the bmag value and trim code.

13. The DC calibration method of claim 12, wherein the bmag value is chosen from an allowable bmag range and the trim code is chosen from an allowable trim code range.

14. The DC calibration method of claim 12, further comprising run time computing a set of model parameters for the mathematical model by obtaining DC level measurements of the receiver system corresponding to distinct combinations of bmag values and trim codes during system boot-up.

15. The DC calibration method of claim 12, wherein the cost function is a square of an error between a predicted DC level from the mathematical model and a target DC level.

16. The DC calibration method of claim 12, wherein the bmag value and the trim code are iteratively updated according to the respective gradients of the cost function and respective damping factors.

17. The DC calibration method of claim 16, wherein the gradient of the cost function for updating the bmag value is derived from partial derivative of the cost function with respect to the bmag value, and the gradient of the cost function for updating the trim code is derived from partial derivative of the cost function with respect to the trim code.

18. The DC calibration method of claim 17, wherein the bmag value is updated by deducting the product of the corresponding gradient and bmag damping factor from the bmag value, and the trim code is updated by deducting the product of the corresponding gradient and trim code damping factor from the trim code.

19. A wireless communication device operating in a wireless communication network, comprising
a receiver system, receiving a signal;
a mixer, down-converting the received signal from a radio frequency to a baseband frequency;
a calibration processor, configured to execute a closed-form DC calibration algorithm to determine a bmag value and trim code, comprising:
deriving a mathematical model for predicting a DC level introduced in the receiver system by run time evaluating one or more model parameters;
selecting an initial bmag value from a predetermined range;
calculating an initial trim code from the initial bmag value according to the mathematical model;
comparing the initial trim code with an allowable trim code range; and
iteratively updating the initial bmag value to recalculate the trim code according to the mathematical model until the trim code is within the allowable trim code range;
wherein the bmag value and trim code are determined when the trim code is within the allowable trim code range;
a DC offset correction circuit, generating a DC correction signal according to the bmag value and trim code determined from the calibration processor; and
a baseband filter and an analog-to-digital converter (ADC), receiving the DC correction signal, removing unwanted frequency components and converting from analog signal to digital samples.

20. The wireless communication device of claim 19, wherein the closed-form DC calibration algorithm further comprises obtaining DC level measurements of the receiver system corresponding to distinct combinations of bmag values and trim codes during system boot-up; and determining a set of model parameters for the mathematical model based on the DC level measurements and the distinct combinations.
